(19) United States
(12) Patent Application Publication
(10) Pub. No.: US 2026/0097968 A1
(43) Pub. Date: Apr. 9, 2026

(54) HIGH-EFFICIENCY SHORT-PROCESS PRODUCTION METHOD AND PRODUCTION SYSTEM FOR CARBONIZED SILICA

(71) Applicant: YUANLI SILICON MATERIALS (NANPING) CO., LTD., Nanping City (CN)

(72) Inventors: Shiguo Fang, Nanping City (CN); Weiqun Chen, Nanping City (CN); Xiangwu Cheng, Nanping City (CN); Liangge Yu, Nanping City (CN); Shiying Huang, Nanping City (CN); Xianglong Lin, Nanping City (CN)

(73) Assignee: YUANLI SILICON MATERIALS (NANPING) CO., LTD., Nanping City (CN)

(21) Appl. No.: 18/977,985

(22) Filed: Dec. 12, 2024

(30) Foreign Application Priority Data
Oct. 8, 2024 (CN) 2024113925748

(51) Int. Cl. C01B 33/193; B01D 25/12; B01J 10/00; B01J 19/00; B01J 19/06

(52) U.S. Cl. CPC C01B 33/193; B01D 25/12; B01J 10/002; B01J 19/0013; B01J 19/0066; B01J 19/06; B01J 2219/00063; B01J 2219/00123; B01J 2219/00164; B01J 2219/00177; B01J 2219/00182

(57) ABSTRACT

A high-efficiency short-process production method and production system for carbonized silica is provided. The absorption reaction is completed in a small gas-liquid carbonization reaction kettle at atmospheric pressure, and the absorption is enhanced through high-intensity stirring and gas-liquid interface contact, so that the rapid and continuous reaction of CO₂ gas and liquid sodium silicate in the carbonization reaction kettle is realized, and the high-efficiency absorption of carbon dioxide is realized under atmospheric pressure reaction conditions. Carbonization reaction is performed in a small-scale carbonization reaction kettle, and precipitation reaction can be performed in a large-scale precipitation reaction kettle according to the scale. Solid-liquid reaction is performed in the precipitation reaction kettle. By controlling the reaction time, reaction temperature and reaction pH, the fine particles of silicon dioxide generated by the absorption reaction are further aggregated and grown to form silicon dioxide particles with stable structure and reliable performance.

### CROSS-REFERENCE TO RELATED APPLICATIONS

This application claims priority of Chinese Patent Application No. 202411392574.8, filed on Oct. 8, 2024, the content of which is hereby incorporated by reference.

### TECHNICAL FIELD

The disclosure relates to the technical field of silica production, in particular to a high-efficiency short-process production method and production system for carbonized silica.

### BACKGROUND OF THE INVENTION

Silica is a general term for amorphous silicic acid and silicate products. Because of its reinforcing effect similar to that of carbon black in rubber industry, it is called silica, with the molecular formula of SiO₂·nH₂O, which is an amorphous silicon dioxide with white appearance. Silica is mainly divided into fumed silica and precipitated silica. Precipitated silica is mainly synthesized by sodium silicate and sulfuric acid. With the improvement of environmental protection requirements and the concern for carbon dioxide emission reduction, carbon dioxide acidification technology has been continuously upgraded and improved, which makes carbon dioxide replace sulfuric acid as a new acidifying agent, which not only helps to reduce environmental pollution, but also achieves the goal of carbon emission reduction. The application of carbon dioxide acidification technology not only meets the current global requirements for environmental protection and sustainable development, but also helps to promote the technological progress and environmental protection upgrade of silica production industry. In this way, carbon dioxide can be recycled with high added value, so as to reduce the emission of carbon dioxide and the carbon footprint of silica products, and at the same time, silica products meeting environmental protection standards can be produced.

The patent application NO. CN202010384373.9 provides a nano-silica used for rubber reinforcement and a preparation method thereof, and the patent application NO. CN201910318339.9 provides a preparation method of spherical silica, which adopt a membrane dispersion reaction tower or a microreactor for carbonization synthesis reaction to increase the reaction efficiency of CO₂, and the production device is relatively complicated. The patent application NO. CN202311127112.9 provides a method for preparing highly dispersible silica by multi-kettle series pressurized carbonization, and the patent application NO. CN202310969463.8 provides a production method for preparing precipitated silica by coupling carbonization of sodium silicate. The carbon dioxide absorption reaction with multi-kettle series pressurized is adopted to prepare silica, and the production device and control process are complicated.

### SUMMARY OF THE INVENTION

In view of this, the purpose of the disclosure is to provide a high-efficiency short-process production method and production system for carbonized silica.

In order to achieve the above technical objectives, the technical scheme adopted by the disclosure is as follows: in the first aspect, a high-efficiency short-process production system for carbonized silica is provided and includes a carbonization assembly, a precipitation assembly, a cooling assembly, a filter assembly, a drying assembly. The carbonization assembly includes a carbonization reaction kettle, a first feed pipe, a second feed pipe, a third feed pipe and a first discharge pipe, where the first feed pipe, the second feed pipe, the third feed pipe and the first discharge pipe are communicated with the carbonization reaction kettle; the first discharge pipe, the second feed pipe and the third feed pipe are respectively communicated with a bottom of the carbonization reaction kettle; the first feed pipe is used for introducing liquid sodium silicate; the second feed pipe is used for introducing first steam; the third feed pipe is used for introducing carbon dioxide gas, a first aqueous solution is contained in the carbonization reaction kettle, and the liquid sodium silicate and the carbon dioxide form a first slurry in the first aqueous solution, and the first discharge pipe is used for outputting the first slurry. The precipitation assembly includes a precipitation reaction kettle, a fourth feed pipe, a second discharge pipe and a third discharge pipe, where a second aqueous solution is contained in the precipitation reaction kettle, the first discharge pipe is communicated with a top of the precipitation reaction kettle, the fourth feed pipe, the second discharge pipe and the third discharge pipe are respectively communicated with a bottom of the precipitation reaction kettle, the fourth feed pipe is used for introducing second steam, and an other end of the second discharge pipe is further communicated with the carbonization reaction kettle, the first slurry forms a second slurry in the precipitation reaction kettle, the second discharge pipe is used for repeatedly introducing the second slurry into the carbonization reaction kettle, and the third discharge pipe is used for outputting the second slurry after precipitation process is completed.

The cooling assembly includes a cooling reaction kettle, a fifth feed pipe, a fourth discharge pipe and a fifth discharge pipe, where the fifth discharge pipe and the fourth discharge pipe are arranged at a bottom of the cooling reaction kettle; the third discharge pipe is communicated with the cooling reaction kettle; the fifth feed pipe is used for introducing circulating cooling water; the fifth discharge pipe is used for outputting the circulating cooling water in the cooling reaction kettle; and the second slurry is cooled in the cooling reaction kettle to form a third slurry, the fourth discharge pipe is used for outputting the third slurry. The filter assembly includes a plate-and-frame filter, a sixth feed pipe and a belt conveyor, where the plate-and-frame filter is communicated with the fourth discharge pipe, the sixth feed pipe is communicated with the plate-and-frame filter, the sixth feed pipe is used for introducing hot water, the belt conveyor is arranged at an output end of the plate-and-frame filter, and the third slurry is repeatedly washed and filtered by the hot water in the plate-and-frame filter to form a filter cake, and the belt conveyor is used for receiving the filtered filter cake. The drying assembly includes a stirring slurry preparation tank, a stirring transition tank and a drying tower, where the stirring slurry preparation tank is connected with an output end of the belt conveyor, an output end of the stirring slurry preparation tank is connected with the stirring transition tank, the drying tower is connected with an output end of the stirring transition tank, the stirring slurry preparation tank is used for mixing the filter cake with a third aqueous solution to form a fourth slurry, the stirring transition tank is used for conveying the fourth slurry into the drying tower, and the drying tower dries the fourth slurry to form a silica product.

In some embodiments, the carbonization assembly further includes a first communicating pipe, one end of the first communicating pipe is communicated with a top of the carbonization reaction kettle, and an other end of the first communicating pipe is communicated with the precipitation reaction kettle, and a communicating end of the first communicating pipe and the precipitation reaction kettle is 10-30 mm lower than a liquid level of the precipitation reaction kettle.

In some embodiments, the precipitation assembly further includes a second communicating pipe, the second communicating pipe is communicated with the top of the precipitation reaction kettle, and the second communicating pipe is also communicated with a spray tower. The cooling assembly further includes a third communicating pipe, the third communicating pipe is communicated with a top of the cooling reaction kettle, and the third communicating pipe is further communicated with the spray tower.

In some embodiments, a first stirrer, a first thermometer, a first material level meter and a first pH meter are arranged in the carbonization reaction kettle, a first flow meter is arranged on the first feed pipe, a second flow meter is arranged on the second feed pipe, and a third flow meter is arranged on the third feed pipe; and/or a second stirrer, a second thermometer, a second material level meter and a second pH meter are arranged in the precipitation reaction kettle, and the fourth flow meter is arranged on the fourth feed pipe; and/or a third stirrer, a third thermometer, a third material level meter and a third pH meter are arranged in the precipitation reaction kettle, and a fifth flow meter is arranged on the fifth feed pipe; and/or a fourth stirrer, a fourth thermometer, a fourth material level meter and a fourth pH meter are arranged in the stirring slurry preparation tank; and/or a fifth stirrer, a fifth thermometer, a fifth material level meter and a fifth pH meter are arranged in the stirring transition tank; and/or, a sixth flow meter is arranged on the first discharge pipe, a seventh flow meter and a first delivery pump are arranged on the second discharge pipe, an eighth flow meter and a second delivery pump are arranged on the third discharge pipe, a ninth flow meter and a third delivery pump are arranged on the fourth discharge pipe, a tenth flow meter is arranged on the fifth discharge pipe, a fourth delivery pump is arranged at a joint of the stirring slurry preparation tank and the stirring transition tank, and a fifth delivery pump is arranged at a joint of the stirring transition tank and the drying tower.

In some embodiments, a ratio of a height to a diameter of the carbonization reaction kettle is not less than 3.

In some embodiments, the first stirrer and/or the second stirrer and/or the third stirrer and/or the fourth stirrer and/or the fifth stirrer is a self-sucking stainless steel high-speed stirrer.

In the second aspect, a high-efficiency short-process production method for carbonized silica is provided, the method is suitable for the production system described in the first aspect, the method includes:
continuously adding liquid sodium silicate into the carbonization reaction kettle, simultaneously continuously adding carbon dioxide from the bottom of the carbonization reaction kettle, and introducing first steam into the carbonization reaction kettle to maintain temperature of the carbonization reaction kettle, where mass concentration of the liquid sodium silicate is 15%-30% and modulus of the liquid sodium silicate is 3.3-3.5;
generating carbonization reaction between the liquid sodium silicate, the carbon dioxide and the first aqueous solution to obtain the first slurry;
conveying the first slurry into the precipitation reaction kettle, adding second steam into the precipitation reaction kettle to maintain temperature of the precipitation reaction kettle, and repeatedly pumping the first slurry of the precipitation reaction kettle into the carbonization reaction kettle to maintain liquid levels of the carbonization reaction kettle and the precipitation reaction kettle;
precipitating carbonized product from the first slurry in the precipitation reaction kettle to form the second slurry;
conveying the second slurry into the cooling reaction kettle, adding circulating cooling water into the cooling reaction kettle, and cooling the second slurry to form the third slurry;
conveying the third slurry to the plate-and-frame filter, and introducing hot water into the plate-and-frame filter to wash the third slurry to form the filter cake;
discharging the filter cake to the belt conveyor, and entering the stirring slurry preparation tank under conveying of the belt conveyor, where the stirring slurry preparation tank mixes the filter cake with a third aqueous solution to prepare slurry to form silica slurry;
conveying the silica slurry into a drying tower through the stirring transition tank, and drying the silica slurry by the drying tower to obtain the silica slurry product.

In some embodiments, a stirring frequency of the carbonization reaction kettle is not less than 100 r/min, temperature of the first slurry in the carbonization reaction kettle is 70-95 DEG C., pH value of the first slurry is 9-12, and residence time of the first slurry in the carbonization reaction kettle is 3-10 min.

In some embodiments, temperature of the second slurry in the precipitation reaction kettle is 70-95° C., pH value of the second slurry is 9.5-11, residence time of the second slurry in the precipitation reaction kettle is 60-180 min, pH value of the second slurry is 8.5-9.5 when entering next process, and dissolved silicon content of the second slurry is less than 100 ppm.

In some embodiments, temperature of the third slurry of the cooling reaction kettle is not higher than 85° C.

By adopting the technical scheme, compared with the prior art, the disclosure has the beneficial effects that.
1. The absorption reaction of the disclosure is completed in a small gas-liquid carbonization reaction kettle at atmospheric pressure, and the absorption is enhanced through high-intensity stirring and gas-liquid interface contact, so that the rapid and continuous reaction of CO₂ gas and liquid sodium silicate in the carbonization reaction kettle is realized, and the high-efficiency absorption of carbon dioxide is realized under atmospheric pressure reaction conditions. Carbonization reaction is performed in a small-scale absorption reaction kettle, and precipitation reaction can be performed in a large-scale precipitation reaction kettle according to the scale. Solid-liquid reaction is performed in the precipitation reaction kettle. By controlling the reaction time, reaction temperature and reaction pH, the fine particles of silicon dioxide generated by the absorption reaction are further aggregated and grown to form silicon dioxide particles with stable structure and reliable performance, and then the absorption reaction is continued by refluxing, so as to further reduce the pH value of the solution, reduce the precipitation content of dissolved silicon dioxide in the solution. So that the particle structure is stable and the performance is reliable, and the utilization efficiency of raw materials is improved.

According to the carbon dioxide carbonized silica production process, the synthesis reaction is decomposed into two reaction processes, namely carbonization reaction and precipitation reaction, so that the production can be continuous, and the problems that the carbon dioxide absorption rate needs to be improved through relatively high pressure and temperature or multi-stage series forced gas-liquid reaction when the scale of the traditional integrated synthesis reaction kettle is enlarged, and the production lacks continuity, and the traditional gas-liquid contact is insufficient, and the carbon dioxide absorption rate in the reaction process is low are solved.
2. In the disclosure, liquid sodium silicate and CO₂ can be simultaneously and continuously added into the carbonization reaction kettle for carbon dioxide carbonization reaction, and the precipitation reaction and the cooling reaction can be continuously performed. Meanwhile, the carbonization reaction kettle is equipped with slurry circulation to trigger the carbonization chain reaction of CO₂, so that carbon dioxide can be efficiently carbonized and transformed, the carbonization reaction speed of CO₂ can be improved, and then the carbon dioxide enters the precipitation reaction kettle to continue the reaction, and at the same time, when entering the cooling reaction kettle, the silicon dioxide continues to undergo polycondensation and temperature change growth.
3. Liquid sodium silicate with high mass concentration can be used as raw material, and the mass concentration of liquid sodium silicate can reach 20-30%, thus improving the reaction efficiency and yield per unit volume during the reaction.

### BRIEF DESCRIPTION OF THE DRAWINGS

In order to more clearly explain the embodiments of the disclosure or the technical scheme in the prior art, the drawings needed to be used in the description of the embodiments or the prior art will be briefly introduced below. Obviously, the drawings in the following description are only some embodiments of the disclosure, for ordinary skilled in this field, other drawings can be obtained according to these drawings without creative work.

FIG. 1 is a schematic diagram of a high-efficiency short-process production system for carbonized silica; and

FIG. 2 is a high-efficiency short-flow production flow chart of carbonized silica.

List of reference characters: 101 carbonization reaction kettle; 102 first feed pipe; 103 second feed pipe; 104 third feed pipe; 105 first discharge pipe; 106 first communicating pipe; 107 first flow meter; 108 second flow meter; 109 third flow meter; 110 sixth flow meter;
201 precipitation reaction kettle; 202 fourth feed pipe; 203 second discharge pipe; 204 third discharge pipe; 205 second communicating pipe; 206 fourth flow meter; 207 seventh flow meter; 208 eighth flow meter; 209 first delivery pump; 210 second delivery pump;
301 cooling reaction kettle; 302 fourth discharge pipe; 303 fifth feed pipe; 304 fifth discharge pipe; 305 third communicating pipe; 306 fifth flow meter; 307 ninth flow meter; 308 tenth flow meter; 309 third delivery pump;
401 plate-and-frame filter; 402 belt conveyor; 403 sixth feed pipe;
501 stirring slurry preparation tank; 502 stirring transition tank; 503 drying tower; 504 fourth delivery pump; and 505 fifth delivery pump.

### DETAILED DESCRIPTION OF THE INVENTION

In the following, the disclosure will be described in further detail with the attached drawings and embodiments. It is particularly pointed out that the following embodiments are only used to illustrate the disclosure, but do not limit the scope of the disclosure. Similarly, the following embodiments are only a part of embodiments of the disclosure, but not all of the embodiments. All other embodiments obtained by ordinary skilled in the field without creative work belong to the scope of protection of the disclosure.

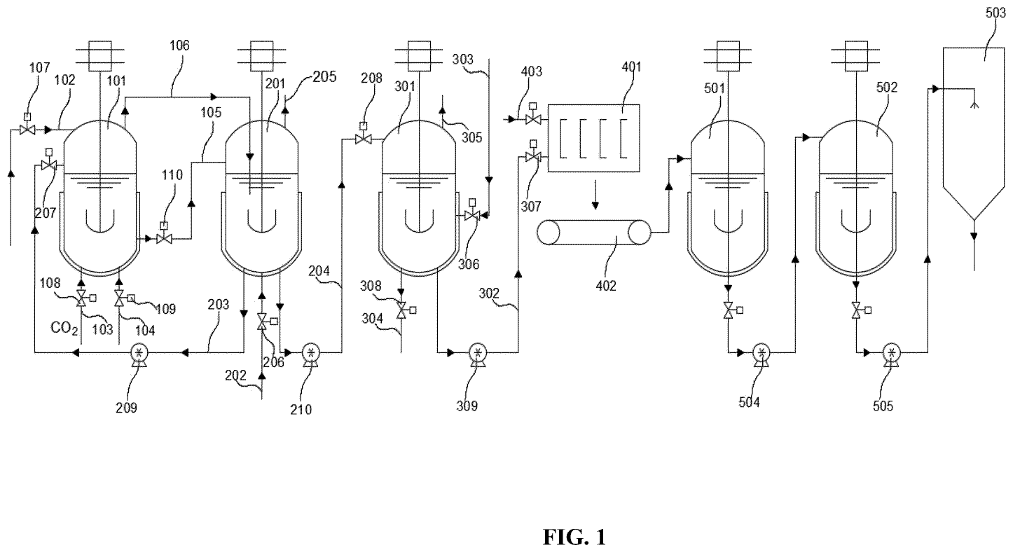

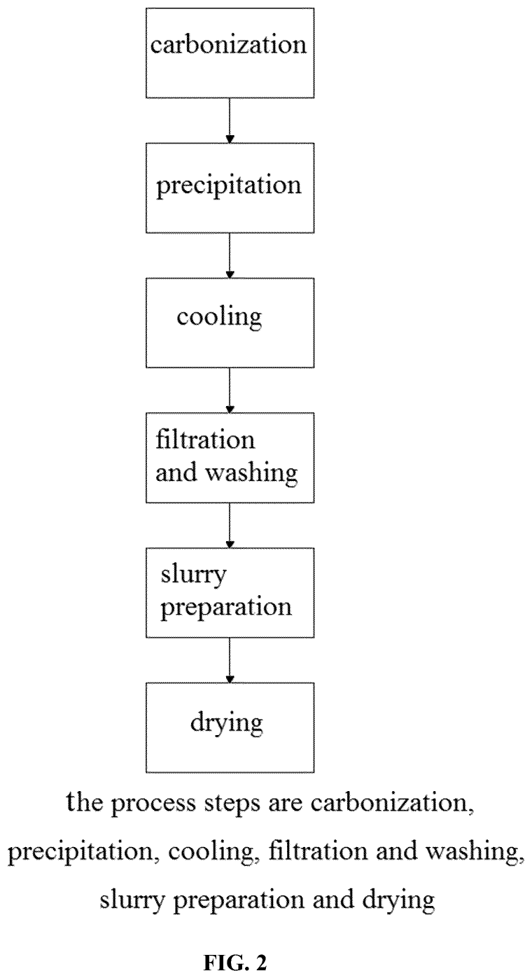

Referring to FIGS. 1 and 2, in a first aspect, a high-efficiency short-process production system for carbonized silica is provided and includes a carbonization assembly, a precipitation assembly, a cooling assembly, a filter assembly, a drying assembly. The carbonization assembly includes a carbonization reaction kettle 101, a first feed pipe 102, a second feed pipe 103, a third feed pipe 104 and a first discharge pipe 105, where the first feed pipe 102, the second feed pipe 103, the third feed pipe 104 and the first discharge pipe 105 are communicated with the carbonization reaction kettle 101; the first discharge pipe 105, the second feed pipe 103 and the third feed pipe 104 are respectively communicated with a bottom of the carbonization reaction kettle 101; the first feed pipe 102 is used for introducing liquid sodium silicate; the second feed pipe 103 is used for introducing first steam; the third feed pipe 104 is used for introducing carbon dioxide gas, a first aqueous solution is contained in the carbonization reaction kettle 101, and the liquid sodium silicate and the carbon dioxide form a first slurry in the first aqueous solution, and the first discharge pipe 105 is used for outputting the first slurry. The precipitation assembly includes a precipitation reaction kettle 201, a fourth feed pipe 202, a second discharge pipe 203 and a third discharge pipe 204, where a second aqueous solution is contained in the precipitation reaction kettle 201, the first discharge pipe 105 is communicated with a top of the precipitation reaction kettle 201, the fourth feed pipe 202, the second discharge pipe 203 and the third discharge pipe 204 are respectively communicated with a bottom of the precipitation reaction kettle 201, the fourth feed pipe 202 is used for introducing second steam, and an other end of the second discharge pipe 203 is further communicated with the carbonization reaction kettle 101, the first slurry forms a second slurry in the precipitation reaction kettle 201, the second discharge pipe 203 is used for repeatedly introducing the second slurry into the carbonization reaction kettle 101, and the third discharge pipe 204 is used for outputting the second slurry after precipitation process is completed.

The cooling assembly includes a cooling reaction kettle 301, a fifth feed pipe 303, a fourth discharge pipe 302 and a fifth discharge pipe 304, where the fifth discharge pipe 304 and the fourth discharge pipe 302 are arranged at a bottom of the cooling reaction kettle 301; the third discharge pipe 204 is communicated with the cooling reaction kettle 301; the fifth feed pipe 303 is used for introducing circulating cooling water; the fifth discharge pipe 304 is used for outputting the circulating cooling water in the cooling reaction kettle 301; and the second slurry is cooled in the cooling reaction kettle 301 to form a third slurry, the fourth discharge pipe 302 is used for outputting the third slurry. The filter assembly includes a plate-and-frame filter 401, a sixth feed pipe 403 and a belt conveyor 402, where the plate-and-frame filter 401 is communicated with the fourth discharge pipe 302, the sixth feed pipe 403 is communicated with the plate-and-frame filter 401, the sixth feed pipe 403 is used for introducing hot water, the belt conveyor 402 is arranged at an output end of the plate-and-frame filter 401, and the third slurry is repeatedly washed and filtered by the hot water in the plate-and-frame filter 401 to form a filter cake, and the belt conveyor 402 is used for receiving the filtered filter cake. The drying assembly includes a stirring slurry preparation tank 501, a stirring transition tank 502 and a drying tower 503, where the stirring slurry preparation tank 501 is connected with an output end of the belt conveyor 402, an output end of the stirring slurry preparation tank 501 is connected with the stirring transition tank 502, the drying tower 503 is connected with an output end of the stirring transition tank 502, the stirring slurry preparation tank 501 is used for mixing the filter cake with a third aqueous solution to form a fourth slurry, the stirring transition tank 502 is used for conveying the fourth slurry into the drying tower 503, and the drying tower 503 dries the fourth slurry to form a silica product.

It should be noted that this embodiment is suitable for the production process of carbonized silica. The whole production process of silica includes the steps of carbonization, precipitation, cooling, filtration and washing, slurry preparation and drying. The carbonization reaction is a chemical reaction between sodium silicate and carbon dioxide in aqueous solution. Specifically, CO₂ completes the carbonation reaction in the carbonization reaction kettle 101. Due to the addition of sodium silicate, the overall carbonization reaction kettle 101 is in an alkaline environment. In this environment, carbon dioxide (CO₂) reacts with water and continuously hydrolyzes to generate carbonic acid (H₂CO₃). Carbonic acid is a weak acid, which is further ionized to generate bicarbonate ion (HCO₃—) and hydrogen ion (H⁺), which can be further ionized to generate carbonate ion (CO₃²⁻) and two hydrogen ions (H⁺).

The hydrolysis chemical equation of carbon dioxide is as follows:

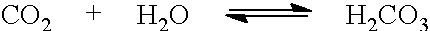

Under alkaline conditions, carbonic acid is further ionized:

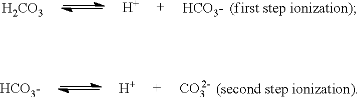

In the absorption reaction, sodium silicate (Na₂O·nSiO₂) reacts with hydrogen ions ionized by carbonic acid to produce sodium, and the sodium further precipitates to form silica (SiO₂) particles. The reaction equation is as follows:

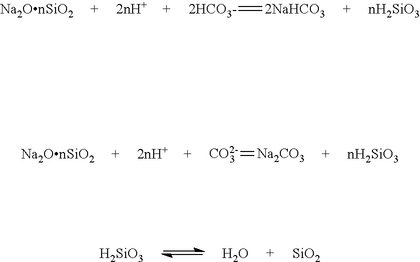

In the whole absorption reaction and precipitation reaction, carbonate and bicarbonate converted from carbon dioxide into ionic form will all participate in the absorption reaction, and the consumption of escaped carbon dioxide that does not participate in the absorption reaction accounts for less than 10% of the total consumption, that is to say, the absorption reaction efficiency of carbon dioxide is not less than 90%.

The carbonized product (that is, slurry containing silica) is precipitated to separate silica from the reaction solution. After that, the slurry containing silica obtained by precipitation is cooled to make it reach a suitable temperature. The cooled slurry containing silica is passed through a filtering device to remove impurities and excess liquid. The filtered silica product is mixed with a proper amount of liquid (such as water, solvent, etc.) and evenly mixed to form silica slurry, which does not contain impurities and other solid particles before filtration. This step is usually performed in the stirring slurry preparation tank 501, and the purpose of stirring is to uniformly disperse the silica in the liquid. The silica slurry is smoothly transported from the stirring slurry preparation tank 501 to the next processing device, such as filters and dryers, for drying, so as to obtain the final silica product.

Based on the aforementioned process flow, the production system shown in this embodiment includes a carbonization assembly, a precipitation assembly, a cooling assembly, a filtering assembly and a drying assembly. Among them, the carbonization assembly includes a carbonization reaction kettle 101, and the carbonization reaction kettle 101 can be a small carbonization reaction kettle 101, which is not limited in this embodiment. The carbonization reaction kettle 101 is filled with water solution, which is pure water. When liquid sodium silicate is introduced into the pure water, carbon dioxide and steam are introduced, where the steam is used to keep the temperature in the pure water solution, and carbon dioxide and liquid sodium silicate are in water to produce the chemical reaction shown above to form slurry containing silica, which is recorded as the first slurry for convenience of understanding.

Further, a precipitation reaction kettle 201 is arranged in the precipitation assembly, and the precipitation reaction kettle 201 and the carbonization reaction kettle 101 are two independent reaction kettles. An aqueous solution, which is pure water, can be introduced into the precipitation reaction kettle 201 for precipitation. It should be noted that in this embodiment, the precipitation reaction kettle 201 is further provided with a second discharge pipe 203, the second discharge pipe 203 can re-introduce the solution and the first slurry in the precipitation reaction kettle 201 into the carbonization reaction kettle 101. It can be understood that the use time of the second discharge pipe 203 and the third discharge pipe 204 can be adjusted in order to achieve different use effects. For example, when the first slurry is still in the reaction process, the second discharge pipe 203 and the first discharge pipe 105 can be opened to realize the liquid circulation between the precipitation reaction kettle 201 and the carbonization reaction kettle 101. After precipitation, the third discharge pipe 204 is opened, and the second discharge pipe 203 and the first discharge pipe 105 are closed, so as to output the second slurry formed after the first slurry is precipitated into the precipitation reaction kettle 201. Optionally, after the output of the second slurry in the precipitation reaction kettle 201 is completed, the third discharge pipe 204 can be closed and the second discharge pipe 203 can be opened, so as to re-introduce the solution of the residual first slurry which has not been mixed in the precipitation reaction kettle 201 into the carbonization reaction kettle 101, so as to realize the recycling of the liquid.

In this embodiment, the second slurry is introduced into the cooling reaction kettle 301, and the temperature of the second slurry is reduced in the cooling reaction kettle 301. It should be noted that the cooling reaction kettle 301 realizes the replenishment and output of circulating cooling water through the fifth feed pipe 303 and the fifth discharge pipe 304, so that the cooling reaction kettle 301 maintains the required cooling temperature and uses water to maintain heat exchange with the second slurry. For the convenience of description, the cooled second slurry is referred to as the third slurry.

Further, in this embodiment, a plate-and-frame filter 401 is set, and the third slurry is introduced into the plate-and-frame filter 401, and at the same time, hot water is introduced into the sixth feed pipe 403, which can wash the third slurry to remove the residual liquid, ions, etc. in the third slurry, and finally a silica product is obtained. For convenience of expression, the silica product is expressed by a filter cake. The filter cake is output from the output end of the plate-and-frame filter 401 to the belt conveyor 402, and is conveyed to the stirring slurry preparation tank 501 by the belt conveyor 402. For example, the stirring slurry preparation tank 501 can be filled with pure water, and pure water is used to prepare slurry for the filter cake, so that the silica product can be fully prepared slurry in water. The stirring transition tank 502 can be understood as a conveying tank to keep the stirring intensity, which can keep the silica solution formed after the silica product is mixed in water in a turbid state and avoid the precipitation of the silica product in the tank. Finally, the stirring transition tank 502 introduces the silica solution into the drying tower 503, and the drying tower 503 takes away the water molecules in the silica solution, thus obtaining the silica product.

It should be noted that the precipitation reaction kettle 201, carbonization reaction kettle 101 and cooling reaction kettle 301 described in this embodiment are all independent devices. Under this condition, the sizes and quantities of precipitation reaction kettle 201, carbonization reaction kettle 101 and cooling reaction kettle 301 can be adjusted according to actual needs, and the whole production system has great flexibility in modification. At the same time, the absorption reaction of this embodiment is completed in the atmospheric gas-liquid small carbonization reaction kettle 101, and the absorption is enhanced by high-intensity stirring and gas-liquid interface contact, so that the rapid and continuous reaction of CO₂ gas and liquid sodium silicate in the carbonization reaction kettle 101 is realized, and the efficient absorption of carbon dioxide is realized under the atmospheric reaction conditions. The carbonization reaction is performed in a small carbonization reaction kettle 101, and the precipitation reaction can be carried out in a large precipitation reaction kettle 201 according to the scale, and the solid-liquid reaction is performed in the precipitation reaction kettle 201. By controlling the reaction time, reaction temperature and reaction pH, the fine particles of silicon dioxide generated by absorption reaction can further aggregate and grow to form silicon dioxide particles with stable structure and reliable performance. Then it is refluxed to continue the absorption reaction, further reducing the pH value of the solution, reducing the precipitation content of dissolved silica in the solution, absorbing carbon dioxide, making the particle structure stable and the performance reliable, and improving the utilization efficiency of raw materials. In the carbon dioxide carbonization process for producing silica shown in this embodiment, the synthesis reaction is decomposed into two reaction processes, namely carbonization reaction and precipitation reaction, so that the production can be continuous, and the problems that the carbon dioxide absorption rate needs to be improved through relatively high pressure and temperature or multi-stage series forced gas-liquid reaction when the scale of the traditional integrated synthesis reaction kettle is enlarged, and the production lacks continuity, and the traditional gas-liquid contact is insufficient, and the carbon dioxide absorption rate in the reaction process is low are solved. In the embodiment liquid sodium silicate and CO₂ can be simultaneously and continuously added into the carbonization reaction kettle 101 for carbon dioxide carbonization reaction, and the precipitation reaction and the cooling reaction can be continuously performed. Meanwhile, the carbonization reaction kettle 101 is equipped with slurry circulation to trigger the carbonization chain reaction of CO₂, so that carbon dioxide can be efficiently carbonized and transformed, the carbonization reaction speed of CO₂ can be improved, and then the carbon dioxide enters the precipitation reaction kettle 201 to continue the reaction, and at the same time, when entering the cooling reaction kettle 301, the silicon dioxide continues to undergo polycondensation and temperature change growth. Liquid sodium silicate with high mass concentration can be used as raw material, and the mass concentration of liquid sodium silicate can reach 20-30%, thus improving the reaction efficiency and yield per unit volume during the reaction.

In some embodiments, the carbonization assembly further includes a first communicating pipe 106, one end of the first communicating pipe 106 is communicated with a top of the carbonization reaction kettle 101, and an other end of the first communicating pipe 106 is communicated with the precipitation reaction kettle 201, and a communicating end of the first communicating pipe 106 and the precipitation reaction kettle is 10-30 mm lower than a liquid level of the precipitation reaction kettle 201.

The first communicating pipe 106 is connected with the upper part of the carbonization reaction kettle 101, and the communication end between the first communicating pipe 106 and the precipitation reaction kettle 201 is 10-30 mm lower than the liquid level in the precipitation reaction kettle 201 to recover the remaining carbon dioxide gas. At the same time, the first communicating pipe 106 is also used to buffer the air pressure in the precipitation reaction kettle 201.

In some embodiments, the precipitation assembly further includes a second communicating pipe 205, the second communicating pipe 205 is communicated with the top of the precipitation reaction kettle 201, and the second communicating pipe 205 is also communicated with a spray tower. The cooling assembly further includes a third communicating pipe 305, the third communicating pipe 305 is communicated with a top of the cooling reaction kettle 301, and the third communicating pipe 305 is further communicated with the spray tower.

The arrangement of the second communicating pipe 205 and the third communicating pipe 305 can recover the participating heat in the precipitation reaction kettle 201 and the cooling reaction kettle 301, and realize the air pressure balance in the cooling reaction kettle 301 and the precipitation reaction kettle 201. It should be noted that the spray tower is a circulating spray tower, which can be set according to the actual demand, and can also be used by other device in the area where the whole production system is located, so as to fully save the production cost and realize the diversified utilization of energy.

In some embodiments, a first stirrer, a first thermometer, a first material level meter and a first pH meter are arranged in the carbonization reaction kettle 101, a first flow meter 107 is arranged on the first feed pipe 102, a second flow meter 108 is arranged on the second feed pipe 103, and a third flow meter 109 is arranged on the third feed pipe 104; and/or a second stirrer, a second thermometer, a second material level meter and a second pH meter are arranged in the precipitation reaction kettle 201, and the fourth flow meter 206 is arranged on the fourth feed pipe 202; and/or a third stirrer, a third thermometer, a third material level meter and a third pH meter are arranged in the precipitation reaction kettle 201, and a fifth flow meter 306 is arranged on the fifth feed pipe 303; and/or a fourth stirrer, a fourth thermometer, a fourth material level meter and a fourth pH meter are arranged in the stirring slurry preparation tank 501; and/or a fifth stirrer, a fifth thermometer, a fifth material level meter and a fifth pH meter are arranged in the stirring transition tank 502; and/or, a sixth flow meter 110 is arranged on the first discharge pipe 105, a seventh flow meter 207 and a first delivery pump 209 are arranged on the second discharge pipe 203, an eighth flow meter 208 and a second delivery pump 210 are arranged on the third discharge pipe 204, a ninth flow meter 307 and a third delivery pump 309 are arranged on the fourth discharge pipe 302, a tenth flow meter 308 is arranged on the fifth discharge pipe 304, a fourth delivery pump 504 is arranged at a joint of the stirring slurry preparation tank 501 and the stirring transition tank 502, and a fifth delivery pump 505 is arranged at a joint of the stirring transition tank 502 and the drying tower 503.

In some embodiments, a ratio of a height to a diameter of the carbonization reaction kettle 101 is not less than 3.

In some embodiments, the first stirrer and/or the second stirrer and/or the third stirrer and/or the fourth stirrer and/or the fifth stirrer is a self-sucking stainless steel high-speed stirrer.

By arranging the first stirrer, the second stirrer, the third stirrer, the fourth stirrer and the fifth stirrer, the production efficiency of the whole silica can be improved. Each device is equipped with a thermometer, a material level meter and a pH meter, which can monitor and adjust the temperature, material level and pH of multiple devices. At the same time, a flow meter is arranged on multiple pipelines, which can realize the accurate transportation and adjustment of various materials.

Referring to FIG. 2, in a second aspect, a high-efficiency short-process production method for carbonized silica is provided, which is suitable for the production system described in the first aspect, and the method includes:
liquid sodium silicate is continuously added into the carbonization reaction kettle, simultaneously carbon dioxide is continuously added from the bottom of the carbonization reaction kettle, and first steam is introduced into the carbonization reaction kettle to maintain temperature of the carbonization reaction kettle, where mass concentration of the liquid sodium silicate is 15-30% and modulus of the liquid sodium silicate is 3.3-3.5;
carbonization reaction is generated between the liquid sodium silicate, the carbon dioxide and the first aqueous solution to obtain the first slurry;
the first slurry is conveyed into the precipitation reaction kettle, second steam is added into the precipitation reaction kettle to maintain temperature of the precipitation reaction kettle, and the first slurry of the precipitation reaction kettle is repeatedly pumped into the carbonization reaction kettle to maintain liquid levels of the carbonization reaction kettle and the precipitation reaction kettle;
carbonized product from the first slurry in the precipitation reaction kettle is precipitated to form the second slurry;
the second slurry is conveyed into the cooling reaction kettle, circulating cooling water is added into the cooling reaction kettle, and the second slurry is cooled to form the third slurry;
the third slurry is conveyed to the plate-and-frame filter, and hot water is introduced into the plate-and-frame filter to wash the third slurry to form the filter cake;
the filter cake is discharged to the belt conveyor, and the stirring slurry preparation tank is entered under conveying of the belt conveyor, where the stirring slurry preparation tank mixes the filter cake with a third aqueous solution to prepare slurry to form silica slurry;
the silica slurry is conveyed into a drying tower through the stirring transition tank, and the silica slurry is dryed by the drying tower to obtain the silica slurry product.

In some embodiments, a stirring frequency of the carbonization reaction kettle is not less than 100 r/min, temperature of the first slurry in the carbonization reaction kettle is 70-95 DEG C., pH value of the first slurry is 9-12, and residence time of the first slurry in the carbonization reaction kettle is 3-10 min.

In some embodiments, temperature of the second slurry in the precipitation reaction kettle is 70-95° C., pH value of the second slurry is 9.5-11, residence time of the second slurry in the precipitation reaction kettle is 60-180 min, pH value of the second slurry is 8.5-9.5 when entering next process, and dissolved silicon content of the second slurry is less than 100 ppm.

In some embodiments, temperature of the third slurry of the cooling reaction kettle is not higher than 85° C.

By adopting the technical scheme, the disclosure has the beneficial effects that.
1. The absorption reaction of the disclosure is completed in a small gas-liquid carbonization reaction kettle at atmospheric pressure, and the absorption is enhanced through high-intensity stirring and gas-liquid interface contact, so that the rapid and continuous reaction of CO₂ gas and liquid sodium silicate in the carbonization reaction kettle is realized, and the high-efficiency absorption of carbon dioxide is realized under atmospheric pressure reaction conditions. Carbonization reaction is performed in a small-scale absorption reaction kettle, and precipitation reaction can be performed in a large-scale precipitation reaction kettle according to the scale. Solid-liquid reaction is performed in the precipitation reaction kettle. By controlling the reaction time, reaction temperature and reaction pH, the fine particles of silicon dioxide generated by the absorption reaction are further aggregated and grown to form silicon dioxide particles with stable structure and reliable performance, and then the absorption reaction is continued by refluxing, so as to further reduce the pH value of the solution, reduce the precipitation content of dissolved silicon dioxide in the solution. So that the particle structure is stable and the performance is reliable, and the utilization efficiency of raw materials is improved.

According to the carbon dioxide carbonized silica production process, the synthesis reaction is decomposed into two reaction processes, namely carbonization reaction and precipitation reaction, so that the production can be continuous, and the problems that the carbon dioxide absorption rate needs to be improved through relatively high pressure and temperature or multi-stage series forced gas-liquid reaction when the scale of the traditional integrated synthesis reaction kettle is enlarged, and the production lacks continuity, and the traditional gas-liquid contact is insufficient, and the carbon dioxide absorption rate in the reaction process is low are solved.
2. In the disclosure, liquid sodium silicate and CO₂ can be simultaneously and continuously added into the carbonization reaction kettle for carbon dioxide carbonization reaction, and the precipitation reaction and the cooling reaction can be continuously performed. Meanwhile, the carbonization reaction kettle is equipped with slurry circulation to trigger the carbonization chain reaction of CO₂, so that carbon dioxide can be efficiently carbonized and transformed, the carbonization reaction speed of CO₂ can be improved, and then the carbon dioxide enters the precipitation reaction kettle to continue the reaction, and at the same time, when entering the cooling reaction kettle, the silicon dioxide continues to undergo polycondensation and temperature change growth.
3. Liquid sodium silicate with high mass concentration can be used as raw material, and the mass concentration of liquid sodium silicate can reach 20-30%, thus improving the reaction efficiency and yield per unit volume during the reaction.

In addition, each functional unit in each embodiment of the disclosure may be integrated into one processing unit, or each unit may exist physically alone, or two or more units may be integrated into one unit. The above integrated units can be realized in the form of hardware or software functional units.

Integrated units can be stored in a computer-readable storage medium if they are implemented in the form of software functional units and sold or used as independent products. Based on this understanding, the technical scheme of the disclosure can be embodied in the form of software products in essence or in part that contributes to the prior art or all or part of the technical scheme. The computer software product is stored in a storage medium and includes several instructions to make a computer device (which can be a personal computer, a server, a network device, etc.) or a processor perform all or part of the steps of the method according to various embodiments of the disclosure. The aforementioned storage media include: U disk, removable hard disk, Read-Only Memory (ROM), Random Access Memory (RAM), magnetic disk or optical disk, and other media that can store program codes.

The above is only part of the embodiments of the disclosure, which does not limit the scope of protection of the disclosure. Any equivalent device or equivalent process transformation made by using the contents of the description and drawings of the disclosure, or directly or indirectly used in other related technical fields, are equally included in the scope of patent protection of the disclosure.

What is claimed is:

1. A high-efficiency short-process production system for carbonized silica, comprising:
a carbonization assembly, wherein the carbonization assembly comprises a carbonization reaction kettle, a first feed pipe, a second feed pipe, a third feed pipe and a first discharge pipe, wherein the first feed pipe, the second feed pipe, the third feed pipe and the first discharge pipe are communicated with the carbonization reaction kettle; the first discharge pipe, the second feed pipe and the third feed pipe are respectively communicated with a bottom of the carbonization reaction kettle; the first feed pipe is used for introducing liquid sodium silicate; the second feed pipe is used for introducing first steam; the third feed pipe is used for introducing carbon dioxide gas, a first aqueous solution is contained in the carbonization reaction kettle, and the liquid sodium silicate and the carbon dioxide form a first slurry in the first aqueous solution, and the first discharge pipe is used for outputting the first slurry;
a precipitation assembly, wherein the precipitation assembly comprises a precipitation reaction kettle, a fourth feed pipe, a second discharge pipe and a third discharge pipe, wherein a second aqueous solution is contained in the precipitation reaction kettle, the first discharge pipe is communicated with a top of the precipitation reaction kettle, the fourth feed pipe, the second discharge pipe and the third discharge pipe are respectively communicated with a bottom of the precipitation reaction kettle, the fourth feed pipe is used for introducing second steam, and an other end of the second discharge pipe is further communicated with the carbonization reaction kettle, the first slurry forms a second slurry in the precipitation reaction kettle, the second discharge pipe is used for repeatedly introducing the second slurry into the carbonization reaction kettle, and the third discharge pipe is used for outputting the second slurry after precipitation process is completed;
a cooling assembly, wherein the cooling assembly comprises a cooling reaction kettle, a fifth feed pipe, a fourth discharge pipe and a fifth discharge pipe, wherein the fifth discharge pipe and the fourth discharge pipe are arranged at a bottom of the cooling reaction kettle; the third discharge pipe is communicated with the cooling reaction kettle; the fifth feed pipe is used for introducing circulating cooling water; the fifth discharge pipe is used for outputting the circulating cooling water in the cooling reaction kettle; and the second slurry is cooled in the cooling reaction kettle to form a third slurry, the fourth discharge pipe is used for outputting the third slurry;
a filter assembly, wherein the filter assembly comprises a plate-and-frame filter, a sixth feed pipe and a belt conveyor, wherein the plate-and-frame filter is communicated with the fourth discharge pipe, the sixth feed pipe is communicated with the plate-and-frame filter, the sixth feed pipe is used for introducing hot water, the belt conveyor is arranged at an output end of the plate-and-frame filter, and the third slurry is repeatedly washed and filtered by the hot water in the plate-and-frame filter to form a filter cake, and the belt conveyor is used for receiving the filtered filter cake;
a drying assembly, wherein the drying assembly comprises a stirring slurry preparation tank, a stirring transition tank and a drying tower, wherein the stirring slurry preparation tank is connected with an output end of the belt conveyor, an output end of the stirring slurry preparation tank is connected with the stirring transition tank, the drying tower is connected with an output end of the stirring transition tank, the stirring slurry preparation tank is used for mixing the filter cake with a third aqueous solution to form a fourth slurry, the stirring transition tank is used for conveying the fourth slurry into the drying tower, and the drying tower dries the fourth slurry to form a silica product.

2. The high-efficiency short-process production system for carbonized silica according to claim 1, wherein the carbonization assembly further comprises a first communicating pipe, one end of the first communicating pipe is communicated with a top of the carbonization reaction kettle, and an other end of the first communicating pipe is communicated with the precipitation reaction kettle, and a communicating end of the first communicating pipe and the precipitation reaction kettle is 10-30 mm lower than a liquid level of the precipitation reaction kettle.

3. The high-efficiency short-process production system for carbonized silica according to claim 2, wherein the precipitation assembly further comprises a second communicating pipe, the second communicating pipe is communicated with the top of the precipitation reaction kettle, and the second communicating pipe is also communicated with a spray tower;
the cooling assembly further comprises a third communicating pipe, the third communicating pipe is communicated with a top of the cooling reaction kettle, and the third communicating pipe is further communicated with the spray tower.

4. The high-efficiency short-process production system for carbonized silica according to claim 3, wherein a first stirrer, a first thermometer, a first material level meter and a first pH meter are arranged in the carbonization reaction kettle, a first flow meter is arranged on the first feed pipe, a second flow meter is arranged on the second feed pipe, and a third flow meter is arranged on the third feed pipe;
and/or a second stirrer, a second thermometer, a second material level meter and a second pH meter are arranged in the precipitation reaction kettle, and the fourth flow meter is arranged on the fourth feed pipe;
and/or a third stirrer, a third thermometer, a third material level meter and a third pH meter are arranged in the precipitation reaction kettle, and a fifth flow meter is arranged on the fifth feed pipe;
and/or a fourth stirrer, a fourth thermometer, a fourth material level meter and a fourth pH meter are arranged in the stirring slurry preparation tank;
and/or a fifth stirrer, a fifth thermometer, a fifth material level meter and a fifth pH meter are arranged in the stirring transition tank;
and/or, a sixth flow meter is arranged on the first discharge pipe, a seventh flow meter and a first delivery pump are arranged on the second discharge pipe, an eighth flow meter and a second delivery pump are arranged on the third discharge pipe, a ninth flow meter and a third delivery pump are arranged on the fourth discharge pipe, a tenth flow meter is arranged on the fifth discharge pipe, a fourth delivery pump is arranged at a joint of the stirring slurry preparation tank and the stirring transition tank, and a fifth delivery pump is arranged at a joint of the stirring transition tank and the drying tower.

5. The high-efficiency short-process production system for carbonized silica according to claim 4, wherein a ratio of a height to a diameter of the carbonization reaction kettle is not less than 3.

6. The high-efficiency short-process production system for carbonized silica according to claim 4, wherein the first stirrer and/or the second stirrer and/or the third stirrer and/or the fourth stirrer and/or the fifth stirrer is a self-sucking stainless steel high-speed stirrer.

7. A high-efficiency short-process production method for carbonized silica, wherein the method is suitable for the production system according to claim 1, the method comprises:
continuously adding liquid sodium silicate into the carbonization reaction kettle, simultaneously continuously adding carbon dioxide from the bottom of the carbonization reaction kettle, and introducing first steam into the carbonization reaction kettle to maintain temperature of the carbonization reaction kettle, wherein mass concentration of the liquid sodium silicate is 15-30% and modulus of the liquid sodium silicate is 3.3-3.5;
generating carbonization reaction between the liquid sodium silicate, the carbon dioxide and the first aqueous solution to obtain the first slurry;
conveying the first slurry into the precipitation reaction kettle, adding second steam into the precipitation reaction kettle to maintain temperature of the precipitation reaction kettle, and repeatedly pumping the first slurry of the precipitation reaction kettle into the carbonization reaction kettle to maintain liquid levels of the carbonization reaction kettle and the precipitation reaction kettle;
precipitating carbonized product from the first slurry in the precipitation reaction kettle to form the second slurry;
conveying the second slurry into the cooling reaction kettle, adding circulating cooling water into the cooling reaction kettle, and cooling the second slurry to form the third slurry;
conveying the third slurry to the plate-and-frame filter, and introducing hot water into the plate-and-frame filter to wash the third slurry to form the filter cake;
discharging the filter cake to the belt conveyor, and entering the stirring slurry preparation tank under conveying of the belt conveyor, wherein the stirring slurry preparation tank mixes the filter cake with a third aqueous solution to prepare slurry to form silica slurry;
conveying the silica slurry into a drying tower through the stirring transition tank, and drying the silica slurry by the drying tower to obtain the silica slurry product.

8. The high-efficiency short-process production method for carbonized silica according to claim 7, wherein a stirring frequency of the carbonization reaction kettle is not less than 100 r/min, temperature of the first slurry in the carbonization reaction kettle is 70-95 DEG C., pH value of the first slurry is 9-12, and residence time of the first slurry in the carbonization reaction kettle is 3-10 min.

9. The high-efficiency short-process production method for carbonized silica according to claim 8, wherein temperature of the second slurry in the precipitation reaction kettle is 70-95° C., pH value of the second slurry is 9.5-11, residence time of the second slurry in the precipitation reaction kettle is 60-180 min, pH value of the second slurry is 8.5-9.5 when entering next process, and dissolved silicon content of the second slurry is less than 100 ppm.

10. The high-efficiency short-process production method for carbonized silica according to claim 9, wherein temperature of the third slurry of the cooling reaction kettle is not higher than 85° C.
